(19) United States
(12) Patent Application Publication
(10) Pub. No.: US 2016/0321745 A1
(43) Pub. Date: Nov. 3, 2016

(54) ACCOUNT BINDING PROCESSING METHOD, APPARATUS AND SYSTEM

(71) Applicant: Tencent Technology (Shenzhen) Company Limited, Shenzhen (CN)

(72) Inventors: Dongrui ZHANG, Shenzhen (CN); Jinxing LIU, Shenzhen (CN); Jin WANG, Shenzhen (CN); Jie TU, Shenzhen (CN); Chang LIU, Shenzhen (CN)

(21) Appl. No.: 15/210,518

(22) Filed: Jul. 14, 2016

Related U.S. Application Data
(63) Continuation of application No. PCT/CN2015/075039, filed on Mar. 25, 2015.

(30) Foreign Application Priority Data
Mar. 25, 2014 (CN) 201410115231.7

(51) Int. Cl. G06Q 40/02; G06F 17/30; H04L 29/06

(52) U.S. Cl. CPC G06Q 40/02; H04L 63/10; G06F 17/30477

(57) ABSTRACT

An account binding processing method includes: receiving an account binding request from a client for binding a target account of a first application to a user account of a third-party application, the account binding request including user information affiliated with the third-party application user account; in response to the account binding request, searching an account managing database for a second user account of the first application corresponding to the user information; initiating a binding process between the target account and the user account of the third-party application when the target account matches the second user account; and when the target account does not match the second user account: retrieving, from the account managing database, contact information of the second user account; and sending a binding notification message to the second user account via the contact information, the binding notification message including information of the target account of the first application.

### RELATED APPLICATIONS

This application is a continuation application of PCT Patent Application No. PCT/CN2015/075039, entitled “ACCOUNT BINDING PROCESSING METHOD, APPARATUS AND SYSTEM” filed on Mar. 25, 2015, which claims priority to Chinese Patent Application No. 201410115231.7, “ACCOUNT BINDING PROCESSING METHOD, APPARATUS AND SYSTEM” filed on Mar. 25, 2014, both of which are hereby incorporated by reference in their entirety.

### FIELD OF THE TECHNOLOGY

The present disclosure relates to the field of computer application technologies, and in particular, to an account binding processing method, apparatus and system.

### BACKGROUND OF THE DISCLOSURE

With development of computer technologies and communications technologies, people can perform network activities by using a computer network, a communications network and an electronic device to handle many matters without going out, and can select more and more communications manners.

During various network activities, an account of a user is basically required to identify the user, and the account is a representative of a digital era, includes digits, Chinese or English characters and a combination thereof used by the user to identify the user in a specific project, and may further include some special symbols. Currently, in order to ensure security of an account or in order that a corresponding notification can be obtained in time, a user generally may bind various user information to the account, such as, mobile phone binding, telephone encryption protection, mailbox binding, IP address binding, identity card binding and the like to the account.

In an existing account binding scenario, security is not high, security threats exist, and an illegal user may obtain user information of a user, such as, a mobile phone number, a bank card number, and an identity card number in a manner of defrauding, cracking or mobile phone Trojan, and then bind an account of the illegal user by using the user information obtained by illegal means. For example, after performing cracking to obtain a mobile phone number, an identity card number and a bank card number of a legal user, an illegal user may illegally bind an express payment account for the illegal user, thereby illegally using property of the legal user by using the express payment account and the bank card number.

### SUMMARY

To solve technical problems, embodiments of the present application provide an account binding processing method, apparatus and system, which can securely complete account binding.

In order to solve the foregoing technical problems, the embodiments of the present application provide an account binding processing method, including:

receiving an account binding request of a client for a target account, and receiving binding information submitted by the client based on the binding request;

using one or more pieces of user information in the binding information as search keywords, and searching an account managing database for a user account corresponding to each user information; and

responding, if at least one user account affiliated with the target account exists in found user accounts, to the account binding request, and initiating a binding process between the binding information and the target account.

Correspondingly, the embodiments of the present application further provide an account binding processing apparatus, including:

a receiving module, configured to receive an account binding request of a client for a target account, and receive binding information submitted by the client based on the binding request;

a search module, configured to use one or more pieces of user information in the binding information as search keywords, and search an account managing database for a user account corresponding to each user information; and

a binding processing module, configured to respond, if at least one user account affiliated with the target account exists in found user accounts, to the account binding request, and initiate a binding process between the binding information and the target account.

Correspondingly, the embodiments of the present application further provide an account binding processing system, including: a client and a binding server,

the client being configured to send an account binding request for a target account to the binding server, and submit binding information; and

the binding server being configured to receive the account binding request of the client for the target account, and receive binding information submitted by the client based on the binding request; use one or more pieces of user information in the binding information as search keywords, and search an account managing database for a user account corresponding to each user information; and respond, if at least one user account affiliated with the target account exists in found user accounts, to the account binding request, and initiate a binding process between the binding information and the target account.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent.

### BRIEF DESCRIPTION OF THE DRAWINGS

To describe the technical solutions of the embodiments of the present application or the existing technology more clearly, the accompanying drawings for illustrating the embodiments or the existing technology will be introduced briefly in the following. Apparently, the drawings in the following description are only some embodiments of the present application, and a person of ordinary skill in the art may obtain other drawings based on these accompanying drawings without creative efforts.

FIG. 1 is a schematic flowchart of an account binding processing method according to an embodiment of the present application;

FIG. 2 is a schematic flowchart of another account binding processing method according to an embodiment of the present application;

FIG. 3 is a specific implementation flowchart of still another account binding processing method according to an embodiment of the present application;

FIG. 4 is a schematic diagram of a binding information submitting interface according to an embodiment of the present application;

FIG. 5 is a schematic structural diagram of an account binding processing apparatus according to an embodiment of the present application;

FIG. 6 is a schematic structural diagram of another account binding processing apparatus according to an embodiment of the present application;

FIG. 7 is a schematic structural diagram of a server according to an embodiment of the present application; and

FIG. 8 is a schematic structural diagram of an account binding processing system according to an embodiment of the present application.

### DESCRIPTION OF EMBODIMENTS

The following clearly and completely describes the technical solutions in the embodiments of the present application with reference to the accompanying drawings in the embodiments of the present application. Apparently, the described embodiments are merely a part rather than all of the embodiments of the present application. All other embodiments obtained by a person of ordinary skill in the art based on the embodiments of the present application without creative efforts shall fall within the protection scope of the present disclosure.

In the embodiments of the present application, in a process of performing user information binding on a target account, another user account of the user information that is bound or affiliated in a former service process such as account registration, a consumption service, and an encryption protection service is first determined, the determined another user account and the target account are compared, and when the two are the same or affiliated, a binding process between the target account and the user information is initiated, so that an illegal account binding operation may be prevented to an extent, particularly, an operation of binding a bank card to an express payment account, thereby improving account binding security.

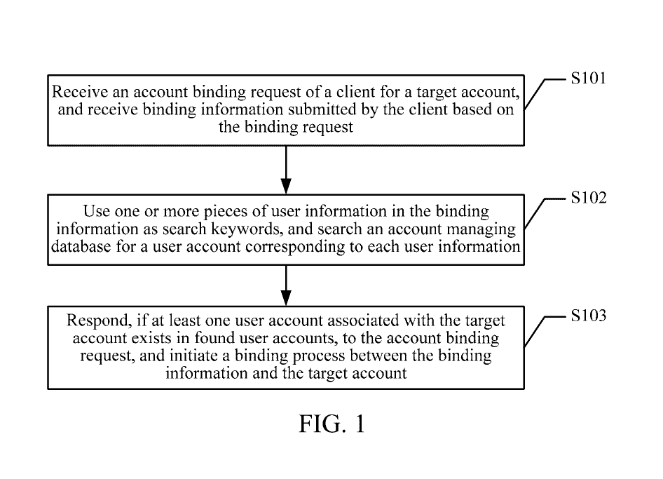

Referring to FIG. 1, FIG. 1 is a schematic flowchart of an account binding processing method according to an embodiment of the present application. The method according to the embodiment of the present application may be applied to a server of a type capable of executing account binding processing such as binding of an express payment account and a bank card, and specifically, the method includes:

S101: Receive an account binding request of a client for a target account, and receive binding information submitted by the client based on the binding request.

The target account may be various accounts obtained by a user by means of registration, such as, an express payment account needing to be bound to a bank card, a mailbox account needing to be bound to a telephone number, and an instant messaging application account. The user may enter, in a related entry item of a provided user interface, binding information needing to be bound to the target account such as bank card number information, user identity information, or communications information for the designated target account, and specifically, for example, when the target account is an express payment account, the user may enter: binding information such as an identity card number, a user name, a mobile phone number affiliated with a bank card and a bank card number.

The client specifically may initiate the account binding request and submit the binding information after the user enters related information and clicks for confirmation. In the embodiment of the present application, the binding information may include multiple pieces of user information, and may also only include one piece of user information as required.

S102: Use one or more pieces of user information in the binding information as search keywords, and search an account managing database for a user account corresponding to each user information.

The account managing database may be obtained based on big data mining and calculation. By collecting related data of various accounts including the target account, such as registration data, consumption order data, and encryption protection data, matching calculation is performed, a series of “account-data” mapping pairs are generated, all the mapping pairs are combined to obtain an account associating database, and the account managing database may be stored in this server, and may also be stored in another storage server authorizing this server to perform search.

For a specific form of the account managing database, reference may be made to what is shown in the following table 1. During specific implementation, the account managing database records a large number of correspondences between user information and a user account, and a keyword search algorithm is configured for the server to search for a user account by using user information as a keyword.

It should be noted that, the user information and the user account are distinguished for convenience of describing the embodiment of the present application. During specific implementation, some pieces of user information may also serve as user accounts, and user accounts may serve as user information of some other accounts. For example, the account managing database may use a bank card number as user information to be corresponding to an express payment account, and may also use it as a user account to be corresponding to a telephone number. Therefore, during search, the server actually may find multiple user accounts based on one piece of user information, for example, by using a bank card number in the foregoing example as a keyword, may perform search to find an express payment account; and meanwhile, by using the bank card number, may further perform search to find a telephone number, and then perform search to find another express payment account by means of the telephone number, and the rest can be deduced by analogy. Content which not only may serve as a user account, but also may serve as user information includes: a bank card number, an instant messaging application account, an electronic mailbox and the like, while content such as an identity card number and a name can only serve as user information.

S103: Respond, if at least one user account affiliated with the target account exists in found user accounts, to the account binding request, and initiate a binding process between the binding information and the target account.

Each found user account and the target account are compared, and if a user account the same as the target account exists, the account binding request is responded to, and the binding process between the binding information and the target account is initiated. Alternatively, likewise, the target account is taken as a keyword, one or more other accounts corresponding to the target account are searched for, and if a user account the same as the target account or another account exists in the found user accounts in S102, the account binding request is responded to, and the binding process between the binding information and the target account is initiated.

The initiating the binding process between the binding information and the target account may be: responding to the account binding request, sending a verification code short message service message to a telephone number in the binding information, and after the user inputs a correct verification code, associatively storing the target account and the binding information, to complete binding. For another example, the account binding request is responded to, a bank server is triggered to send a verification code short message service message to a telephone number reserved for a bank card number and included in the binding information, and after the user inputs a correct verification code, the target account and the binding information are associatively stored, to complete binding.

In a simple example, the following table 1 shows that the account managing database may store user information and user accounts in a table form and in a mapping manner.

TABLE 1

| | | |
|---|---|---|
| Identity card number | Identity card number | Identity card number |
| 1-account 1 | 2-account 2 | 3-account 3 |
| Name 1-account 1 | Name 2-account 2 | Name 3-account 3 |
| Mobile phone number | Mobile phone number | Mobile phone number |
| 1-account 1 | 2-account 2 | 3-account 3 |
| Bank card number | Bank card number | Bank card number |
| 1-account 1 | 2-account 2 | 3-account 3 |

Further, when the binding information submitted for the target account in S101 is: identity card number 1, name 2, mobile phone number 2 and bank card number 3, account 1, account 2 and account 3 may be correspondingly found based on the binding information in S102; in S103, if the target account is the same as or related to any one of the account 1, the account 2 and the account 3, the account binding request is responded to, and the binding process between the binding information and the target account is initiated, where the associating mentioned in the present disclosure may be that the target account is the same as account 1, or account 2, or account 3, or a relationship link between the target account and account 1, or account 2, or account 3 is a friend relationship, or the like.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent.

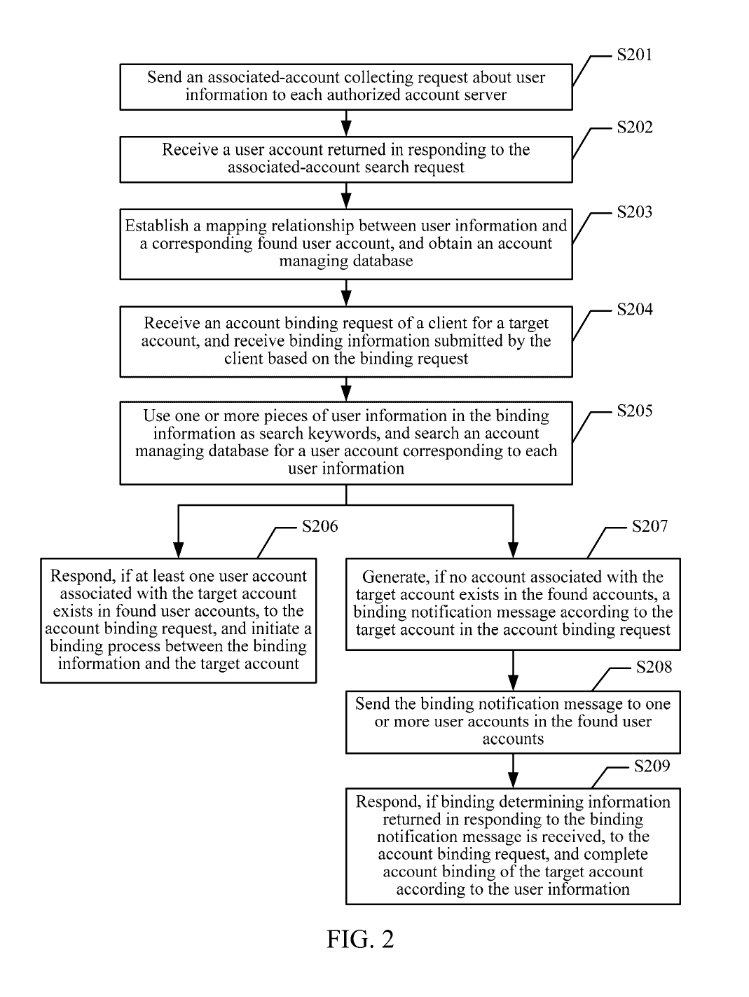

Then referring to FIG. 2, FIG. 2 is a schematic flowchart of another account binding processing method according to an embodiment of the present application. The method according to the embodiment of the present application may be applied to a server of a type of account binding processing such as binding of an express payment account and a bank card, and specifically, the method includes:

S201: Send an affiliated-account search request about user information to each authorized account server.

S202: Receive a user account returned in response to the affiliated-account search request.

S203: Establish a mapping relationship between user information and a corresponding found user account, and obtain an account managing database.

S201 to S203 are steps of establishing the account managing database. In the embodiment of the present application, the server may search various account servers authorized to this server for user accounts and binding information corresponding to the user accounts in a manner of big data mining and calculation, such as, search various instant messaging application servers for an account for account registration and binding information thereof, search for an account recorded in a consumption order in a consumption payment server and binding information such as a telephone number and a bank card number, search encryption protection data for an account and binding information such as a telephone number thereof, and the like.

According to a found user account and user information in each binding information, the account managing database is completed by establishing a mapping table, so as to help directly perform search subsequently. The server may update the account managing database based on big data mining at fixed intervals, to obtain a latest account managing database.

S204: Receive an account binding request of a client for a target account, and receive binding information submitted by the client based on the binding request.

The target account may be various accounts obtained by a user by means of registration, such as, an express payment account needing to be bound to a bank card, a mailbox account needing to be bound to a telephone number, and an instant messaging application account. The user may enter, in a related entry item of a provided user interface, binding information needing to be bound to the target account such as bank card number information, user identity information, or communications information for the designated target account, and specifically, for example, when the target account is an express payment account, the user may enter: binding information such as an identity card number, a user name, a mobile phone number affiliated with a bank card and a bank card number.

The client specifically may initiate the account binding request and submit the binding information after the user enters related information and clicks for confirmation. In the embodiment of the present application, the binding information may include multiple pieces of user information, and may also only include one piece of user information as required.

S205: Use one or more pieces of user information in the binding information as search keywords, and search an account managing database for a user account corresponding to each user information.

A keyword search algorithm is configured for the server to search for a user account by using user information as a keyword.

In other embodiments, an account managing database may be established in a counting server, and the server in the embodiment of the present application searches for a user account corresponding to each user information by sending a search request to the counting server, which specifically includes: using one or more pieces of user information in the binding information as search keywords, sending a search request to a counting server, and searching the account managing database configured by the counting server for a user account corresponding to each user information.

S206: Respond, if at least one user account affiliated with the target account exists in found user accounts, to the account binding request, and initiate a binding process between the binding information and the target account.

Before S206, the method includes a step of judging whether they are affiliated, that is, judging whether at least one user account affiliated with the target account exists in the found user accounts, which specifically may be judged by judging whether the target account is the same as one of the user accounts found according to the user information, or whether a relationship link of the target account is in a friend relationship with one or more user accounts found according to the user information.

S207: Generate, if no account affiliated with the target account exists in the found accounts, a binding notification message according to the target account in the account binding request.

S208: Send the binding notification message to one or more user accounts in the found user accounts.

If no account affiliated with the target account exists in the found accounts, it may be determined that this binding event is suspicious, such as, it may be considered that, in this express payment account binding event, a related user may embezzle content of a legal user, such as a bank card number, a name, an identity card number and a telephone number, and intends to illegally use the bank account of the legal user in a binding manner, and therefore, others accounts affiliated with content such as a bank card number, a name, an identity card number and a telephone number in former use processes, that is, the foregoing found user accounts may be notified in a manner of generating a binding notification message; in this example, an instant messaging application account affiliated with a telephone number may be found by using the telephone number, and in this case, the binding notification message may be sent to the instant messaging application account. It should be noted that, the sent binding notification message includes content such as a verification code, and after the binding notification message is sent, a client bound this time may be first initiated to send a prompt, so as to request a user of the client to input content such as the corresponding verification code.

A type of each found user account is identified, and the binding notification message is sent to a user account of a type at a high priority level according to a priority level of a configured notification channel type. Specifically, a high priority level may be configured for a notification channel of an instant messaging application and an electronic mail, and a low priority level may be configured for other notification channels such as social communications, so as to notify a legal user in time by using a channel at a high priority level. After a notification channel at a high priority level is not determined, a message is sent by using a notification channel at a low priority level, so as to ensure that a legal user can be notified.

S209: Respond, if binding confirmation message returned in response to the binding notification message is received, to the account binding request, and complete account binding of the target account according to the user information.

If the binding confirmation message returned in response to the binding notification message is received, it may be proved that this binding event is initiated by a legal user, the account binding request is responded to, and account binding of the target account is completed according to the user information.

Further specifically, in the embodiment of the present application, the step of judging whether at least one user account affiliated with the target account exists in the found user accounts before S206 specifically may include: judging whether at least one user account same as the target account exists in the user accounts found according to the user information; and determining, if yes, that at least one user account affiliated with the target account exists in the found user accounts. Alternatively, the step specifically may further include: taking the target account as a search keyword, and searching for an affiliated account of the target account; comparing each affiliated account found according to the target account with each user account found according to the user information; and determining, if a same account exists, that at least one user account affiliated with the target account exists in the found user accounts.

An example is used below to simply describe the method of the embodiment of the present application.

A user needs to bind a bank card number and a user identity card number (user information in binding information) to a payment account (target account) for which the user applies.

After receiving a binding request, the server first searches for other accounts (user accounts) according to the bank card number and the user identity card number; because the user may bind one or more other accounts to the bank card number or user identity card number in other scenarios, one or more other user accounts may be correspondingly found, such as other instant messaging accounts.

The server then takes the payment account as a search keyword, and searches for, such as, each affiliated friend account of the payment account, or an instant messaging account already bound to the payment account.

The server then compares the instant messaging account found according to the bank card number and the user identity card number with a friend account found according to a payment account or a bound instant messaging account, and if a same account (a same instant messaging account or the like) is included, it may be determined that the account found according to the bank card number and the user identity card number is affiliated with the target account.

The server may determine that at least one user account affiliated with the target account exists in the found user accounts, and may respond to this binding request to initiate a binding process, or otherwise, does not continue to perform the binding processing, and processes the binding request according to a configured security policy, such as, rejects the binding or notifies a related person to perform a security operation.

It should be noted that, before taking the payment account as a keyword to perform search, the server may first judge whether an account found according to the bank card number and the user identity card number is the same as the target account, that is, the bank card number or identity card number may already be bound to the user account once, or the bank card number occurs once in one payment event of the payment account, and therefore, when the account found according to the bank card number and the user identity card number is the same as the target account, it is directly determined that at least one user account affiliated with the target account exists in the found user accounts. Otherwise, the server executes the process of taking the payment account as a keyword to perform search and subsequent comparing.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent. Moreover, a database including accounts and user information and obtained by using technologies such as big data mining and calculation basically can ensure comprehensive coverage, and may effectively ensure accuracy of judging whether the found user account and the target account needing to be bound are affiliated, so as to avoid misjudgment to an extent. Moreover, when it is detected that they may be bound, a related user can further be notified in time, so as to further ensure account and property security of the legal user.

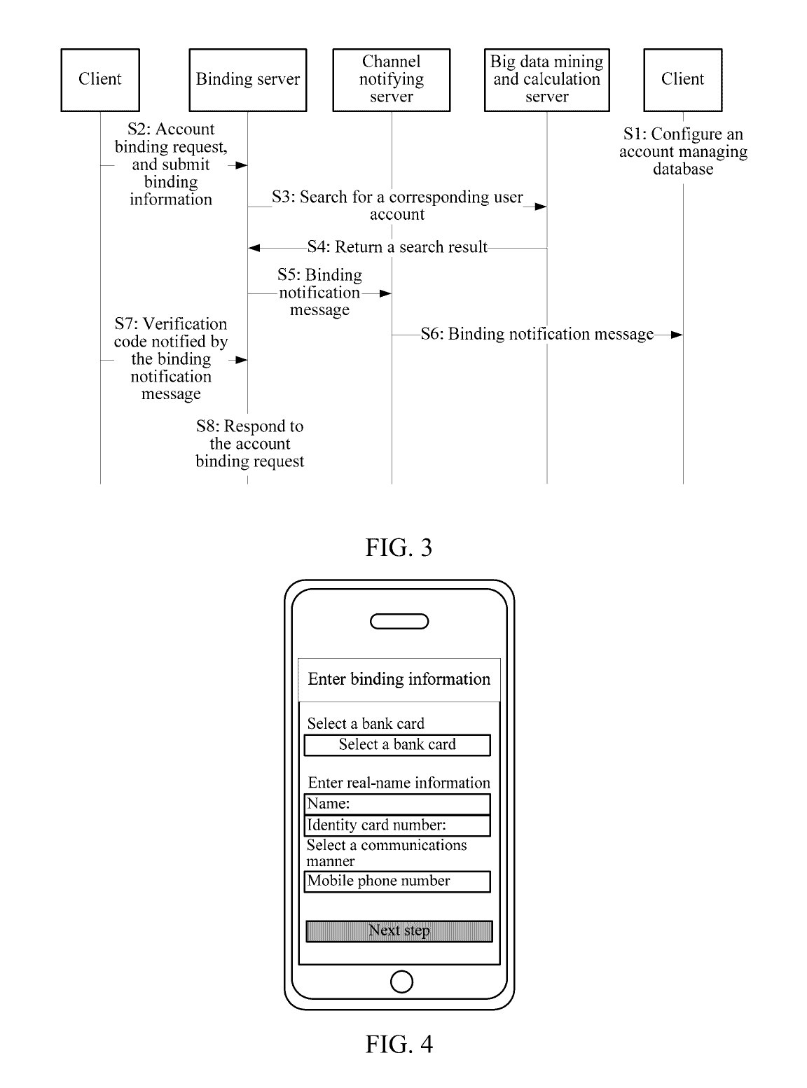

Then referring to FIG. 3, FIG. 3 is a specific implementation flowchart of still another account binding processing method according to an embodiment of the present application. The method according to the embodiment of the present application includes:

S1: A big data mining and calculation server configures an account managing database, which specifically may be obtained based on big data mining and calculation. By collecting related data of various accounts including the target account, such as registration data, consumption order data, and encryption protection data, matching calculation is performed, a series of “account-data” mapping pairs are generated, all the mapping pairs are combined to obtain an account associating database.

S2: A client initiates an account binding request for the target account, and submits binding information. The binding information includes an identity card number, a user name, a mobile phone number affiliated with a bank card, a bank card number and the like. The client may request a user in a manner of providing an interacting interface to enter related information in a corresponding entry item, and initiates a request at the time of clicking a next step, and the specific interface is shown in FIG. 4.

S3: A binding server takes the binding information as a keyword to search the account managing database configured for the big data mining and calculation server for a corresponding user account. Specifically, the binding server searches the account managing database in a manner of communicating with the big data mining and calculation server.

S4: The big data mining and calculation server returns a search result.

S5: The binding server generates a binding notification message and sends it to a channel notifying server when the found user account is different from the target account. When the found user account is the same as the target account, the binding server directly responds to the account binding request, and binds the target account to the submitted binding information. The binding notification message carries one or more found user accounts.

S6: The channel notifying server sends the binding notification message to a client at which the user account found in the binding server is located.

The sent binding notification message includes content such as a verification code, and after the binding notification message is sent, a client bound this time may be first initiated to send a prompt, so as to request a user of the client to input content such as the corresponding verification code.

S7: The binding server receives, from the client initiating the binding request, a verification code notified by the binding notification message. The user may input and submit, according to content such as the verification code included in the binding notification message, the verification code to the client initiating this binding request, so as to complete binding verification. Certainly, the user may also return binding confirmation information to the client receiving the binding notification message, so as to complete binding verification.

S8: Respond to the account binding request, and complete account binding to the target account according to the user information.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent. Moreover, a database including accounts and user information and obtained by using technologies such as big data mining and calculation basically can ensure comprehensive coverage, and may effectively ensure accuracy of judging whether the found user account and the target account needing to be bound are affiliated, so as to avoid misjudgment to an extent. Moreover, when it is detected that they may be bound, a related user can further be notified in time, so as to further ensure account and property security of the legal user.

An account binding processing apparatus and system according to embodiments of the present application are described in detail below.

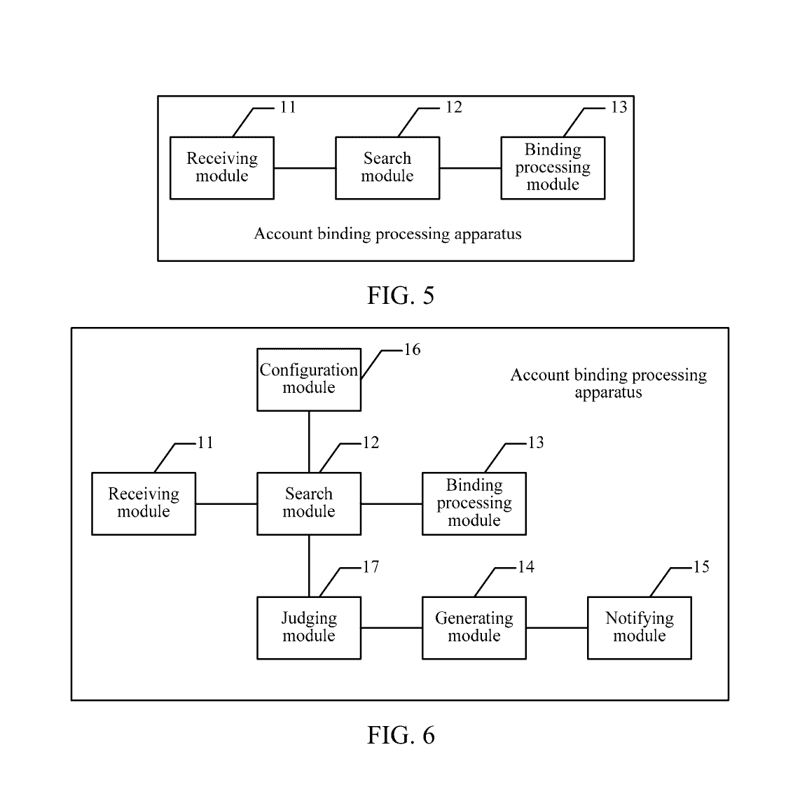

Referring to FIG. 5, FIG. 5 is a schematic structural diagram of an account binding processing apparatus according to an embodiment of the present application. The apparatus according to the embodiment of the present application may be disposed in a server of a type capable of executing account binding processing such as binding of an express payment account and a bank card, and specifically, the apparatus includes:

a receiving module 11, configured to receive an account binding request of a client for a target account, and receive binding information submitted by the client based on the binding request;

a search module 12, configured to use one or more pieces of user information in the binding information as search keywords, and search an account managing database for a user account corresponding to each user information; and

a binding processing module 13, configured to respond, if at least one user account affiliated with the target account exists in found user accounts, to the account binding request, and initiate a binding process between the binding information and the target account.

The target account may be various accounts obtained by a user by means of registration, such as, an express payment account needing to be bound to a bank card, a mailbox account needing to be bound to a telephone number, and an instant messaging application account. The user may enter, in a related entry item of a provided user interface, binding information needing to be bound to the target account such as bank card number information, user identity information, or communications information for the designated target account, and specifically, for example, when the target account is an express payment account, the user may enter: binding information such as an identity card number, a user name, a mobile phone number affiliated with a bank card and a bank card number.

The client specifically may initiate the account binding request and submit the binding information after the user enters related information and clicks for confirmation. In the embodiment of the present application, the binding information may include multiple pieces of user information, and may also only include one piece of user information as required. The client may send the account binding request and the binding information to the server by using an existing computer network, and the receiving module 11 correspondingly receives an account binding request of a client for a target account, and receives binding information submitted by the client based on the binding request.

The account managing database may be obtained based on big data mining and calculation. By collecting related data of various accounts including the target account, such as registration data, consumption order data, and encryption protection data, matching calculation is performed, a series of “account-data” mapping pairs are generated, all the mapping pairs are combined to obtain an account associating database, and the account managing database may be stored in this server, and may also be stored in another storage server authorizing this server to perform search. The search module 12 searches the account managing database for a user account corresponding to each user information in the binding information.

The binding processing module 13 compares each found user account with the target account, and if a user account the same as the target account exists, responds to the account binding request, and initiates the binding process between the binding information and the target account.

The initiating the binding process between the binding information and the target account may be: responding to the account binding request, sending a verification code short message service message to a telephone number in the binding information, and after the user inputs a correct verification code, associatively storing the target account and the binding information, to complete binding. For another example, the account binding request is responded to, a bank server is triggered to send a verification code short message service message to a telephone number reserved for a bank card number and included in the binding information, and after the user inputs a correct verification code, the target account and the binding information are associatively stored, to complete binding.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent.

Then referring to FIG. 6, FIG. 6 is a schematic structural diagram of another account binding processing apparatus according to an embodiment of the present application. The apparatus according to the embodiment of the present application includes a receiving module 11, a search module 12 and a binding processing module 13 in the foregoing embodiment, and further, in the embodiment of the present application, the apparatus further includes:

a generating module 14, configured to generate, if no account affiliated with the target account exists in the found accounts, a binding notification message according to the target account in the account binding request; and

a notifying module 15, configured to send the binding notification message to one or more user accounts in the found user accounts, where

the binding processing module 13 is further configured to respond, if binding confirmation message returned in response to the binding notification message is received, to the account binding request, and complete account binding of the target account according to the user information.

Optionally, the notifying module 15 is specifically configured to identify a type of each found user account, and send the binding notification message to a user account of a type at a high priority level according to a priority level of a configured notification channel type.

If no account affiliated with the target account exists in the accounts found by the search module 12, it may be determined that this binding event is suspicious, such as, it may be considered that, in this express payment account binding event, a related user may embezzle content of a legal user, such as a bank card number, a name, an identity card number and a telephone number, and intends to illegally use the bank account of the legal user in a binding manner, and therefore, others accounts affiliated with content such as a bank card number, a name, an identity card number and a telephone number in former use processes, that is, the notifying module 15 may notify the foregoing found user accounts in a manner of generating a binding notification message by the generating module 14; in this example, an instant messaging application account affiliated with a telephone number may be found by using the telephone number, and in this case, the binding notification message may be sent to the instant messaging application account. It should be noted that, the sent binding notification message includes content such as a verification code, and after the binding notification message is sent, a client bound this time may be first initiated to send a prompt, so as to request a user of the client to input content such as the corresponding verification code.

A type of each found user account is identified, and the binding notification message is sent to a user account of a type at a high priority level according to a priority level of a configured notification channel type. Specifically, a high priority level may be configured for a notification channel of an instant messaging application and an electronic mail, and a low priority level may be configured for other notification channels such as social communications, so that the notifying module 15 notifies a legal user in time by using a channel at a high priority level. After a notification channel at a high priority level is not determined, the notifying module 15 sends a message by using a notification channel at a low priority level, so as to ensure that a legal user can be notified.

Further optionally, the apparatus according to the embodiment of the present application may further include:

a configuration module 16, configured to send an affiliated-account search request about user information to each authorized account server; receive a user account returned in response to the affiliated-account search request; and establish a mapping relationship between user information and a corresponding found user account, and obtain the account managing database.

During specific implementation, the account managing database may also be configured and completed by another counting server, and the search module 12 specifically may be further configured to use one or more pieces of user information in the binding information as search keywords, send a search request to a counting server, and search the account managing database configured by the counting server for a user account corresponding to each user information.

Further optionally, the apparatus according to the embodiment of the present application may further include:

a judging module 17, configured to judge whether at least one user account affiliated with the target account exists in the found user accounts.

The judging module 17 may further include:

a judging unit, configured to judge whether at least one user account same as the target account exists in the user accounts found according to the user information; and

a first determining unit, configured to determine, when a judging result of the judging unit is yes, that at least one user account affiliated with the target account exists in the found user accounts.

Alternatively, the judging module 17 may further include:

a search unit, configured to take the target account as a search keyword, and search for an affiliated account of the target account;

a comparing unit, configured to compare each affiliated account found according to the target account with each user account found according to the user information; and

a second determining unit, configured to determine, when a comparing result of the comparing unit is that a same account exists, that at least one user account affiliated with the target account exists in the found user accounts.

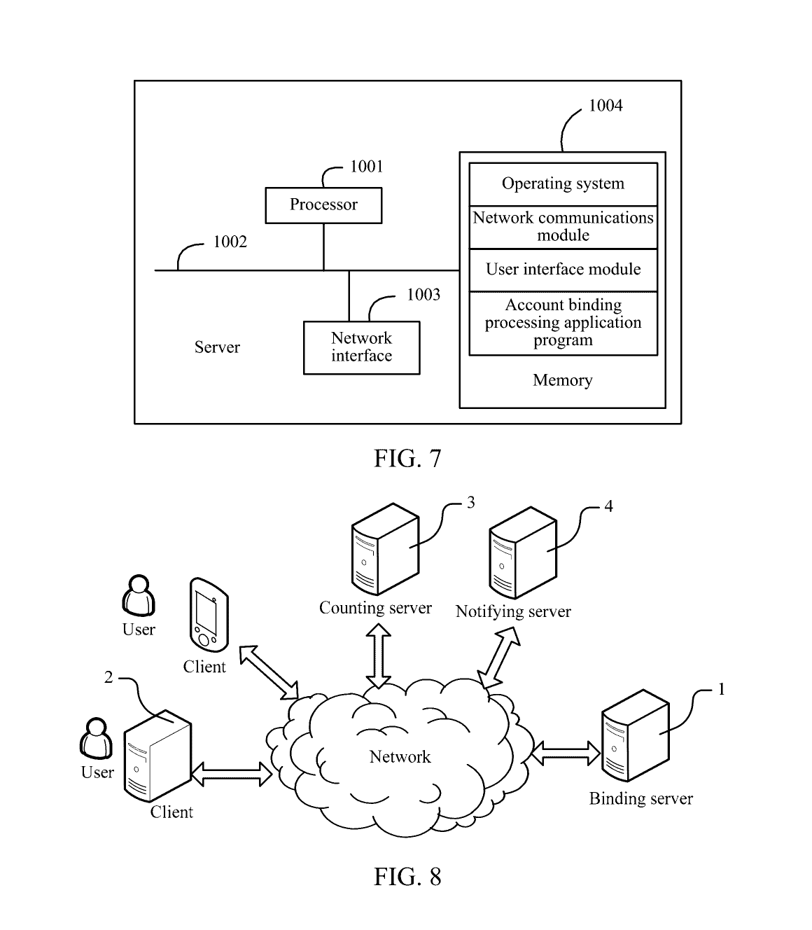

Then referring to FIG. 7, FIG. 7 is a schematic structural diagram of a server according to an embodiment of the present application. The server according to the embodiment of the present application includes: at least one processor 1001, such as a CPU, at least one communications bus 1002, at least one network interface 1003, and a memory 1004. The communications bus 1002 is configured to implement connection and communication between these components. The network interface 1003 optionally may include a standard wired interface, and a wireless interface (such as a WI-FI interface or mobile communications interface). The memory 1004 may be a high-speed RAM memory, and may also be a non-volatile memory, such as at least one magnetic disk memory. The memory 1004 optionally may further be at least one storage apparatus located away from the foregoing processor 1001. As shown in FIG. 7, the memory 1004 serving as a computer storage medium stores an operating system, and a network communications module, and stores an account binding processing application program.

Specifically, the processor 1001 may be configured to invoke the account binding processing application program stored in the memory 1004 to execute the following steps:

receiving an account binding request of a client for a target account, and receiving binding information submitted by the client based on the binding request;

using one or more pieces of user information in the binding information as search keywords, and searching an account managing database for a user account corresponding to each user information; and

responding, if at least one user account affiliated with the target account exists in found user accounts, to the account binding request, and initiating a binding process between the binding information and the target account.

The processor 1001 may be further configured to execute the following steps:

generating, if no account affiliated with the target account exists in the found accounts, a binding notification message according to the target account in the account binding request;

sending the binding notification message to one or more user accounts in the found user accounts; and

responding, if binding confirmation message returned in response to the binding notification message is received, to the account binding request, and completing account binding of the target account according to the user information.

When the processor 1001 is configured to execute the sending the binding notification message to one or more user accounts in the found user accounts, the processor 1001 specifically executes the following steps:

identifying a type of each found user account; and

sending the binding notification message to a user account of a type at a high priority level according to a priority level of a configured notification channel type.

Further, before the processor 1001 is configured to execute the receiving an account binding request of a client for a target account, and receiving user information submitted by the client based on the binding request, the processor 1001 is further configured to execute the following steps:

sending an affiliated-account search request about user information to each authorized account server;

receiving a user account returned in response to the affiliated-account search request; and

establishing a mapping relationship between user information and a corresponding found user account, and obtaining the account managing database.

Alternatively, when the processor 1001 is configured to execute the using one or more pieces of user information in the binding information as search keywords, and searching an account managing database for a user account corresponding to each user information, the processor 1001 is specifically configured to execute the following step:

using one or more pieces of user information in the binding information as search keywords, sending a search request to a counting server, and searching the account managing database configured by the counting server for a user account corresponding to each user information.

Further, before the processor 1001 executes the responding, if at least one user account affiliated with the target account exists in found user accounts, to the account binding request, and initiating a binding process between the binding information and the target account, the processor 1001 is further configured to execute the following step:

judging whether at least one user account affiliated with the target account exists in the found user accounts, where the step specifically includes:

judging whether at least one user account the same as the target account exists in the found user accounts, and determining, if a same user account exists, that at least one user account affiliated with the target account exists in the found user accounts; and/or

taking the target account as a search keyword, and searching for an affiliated account of the target account; and judging whether an account the same as the found user account exists in the found affiliated accounts, and determining, if a same account exists, that at least one user account affiliated with the target account exists in the found user accounts.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent. Moreover, a database including accounts and user information and obtained by using technologies such as big data mining and calculation basically can ensure comprehensive coverage, and may effectively ensure accuracy of judging whether the found user account and the target account needing to be bound are affiliated, so as to avoid misjudgment to an extent. Moreover, when it is detected that they may be bound, a related user can further be notified in time, so as to further ensure account and property security of the legal user.

Then referring to FIG. 8, FIG. 8 is a schematic structural diagram of an account binding processing system according to an embodiment of the present application. The system according to the embodiment of the present application includes: a client 2 and a binding server 1, the client 2 specifically may be an intelligent terminal with a network function, such as a mobile phone, a tablet computer, a personal computer, or an intelligent wearable device, and the binding server 1 may be a server of a type capable of executing account binding processing such as binding of an express payment account and a bank card.

The client 2 is configured to send an account binding request for a target account to the binding server 1, and submit binding information.

The binding server 1 is configured to receive the account binding request of the client 2 for the target account, and receive binding information submitted by the client 2 based on the binding request; use one or more pieces of user information in the binding information as search keywords, and search an account managing database for a user account corresponding to each user information; and respond, if at least one user account affiliated with the target account exists in found user accounts, to the account binding request, and initiate a binding process between the binding information and the target account.

Further optionally, in the embodiment of the present application, the system may further include: a counting server 3, and the account managing database is configured and obtained by the counting server.

The counting server 3 is configured to send an affiliated-account search request about user information to each authorized account server; receive a user account returned in response to the affiliated-account search request; and establish a mapping relationship between user information and a corresponding found user account, and obtain the account managing database. The counting server 3 may be corresponding to the foregoing involved big data mining and calculation server.

The binding server 1 is specifically configured to use one or more pieces of user information in the binding information as search keywords, send a search request to the counting server, and search the account managing database for a user account corresponding to each user information.

Further optionally, in the embodiment of the present application, the system may further include: a notifying server 4.

The binding server 1 is further configured to generate, if no account affiliated with the target account exists in the found accounts, a binding notification message according to the target account in the account binding request, and send the binding notification message to the notifying server.

The notifying server 4 is configured to send the binding notification message to one or more user accounts in the user accounts found by the binding server 1. The notifying server 4 may finally send the binding notification message to the client 2, and may also send the binding notification message to another client shown in FIG. 8, so as to notify a legal user accurately and in time.

For specific implementation of the client 2 and each server in the embodiments of the present application, reference may be made to the description about related content in the embodiments corresponding to FIG. 1 to FIG. 7.

In the embodiments of the present application, when a user initiates binding, an user account is first searched for based on submitted binding information, and when it is determined that the found account is affiliated with a target account needing to be bound, a specific binding process is initiated, so that account binding security can be effectively ensured, and that binding of an illegal account is completed after user information is obtained by means of an illegal channel, can be avoided, so as to ensure account and property security of a legal user to an extent. Moreover, a database including accounts and user information and obtained by using technologies such as big data mining and calculation basically can ensure comprehensive coverage, and may effectively ensure accuracy of judging whether the found user account and the target account needing to be bound are affiliated, so as to avoid misjudgment to an extent. Moreover, when it is detected that they may be bound, a related user can further be notified in time, so as to further ensure account and property security of the legal user.

A person of ordinary skill in the art may understand that all or some of the procedures of the methods of the foregoing embodiments may be implemented by a computer program instructing relevant hardware. The program may be stored in a computer readable storage medium. When the program is executed, the program may include the procedures of the embodiments of the foregoing methods. The storage medium may be a magnetic disk, an optical disc, read-only memory (ROM), a random access memory (RAM) or the like.

The foregoing descriptions are merely exemplary embodiments of the present application, but not intended to limit the scope of the present disclosure. Any equivalent replacement change made according to the appended claims of the present disclosure should fall within the scope of the present disclosure.

What is claimed is:

1. An account binding processing method, including:
at a binding server having one or more processors and memory storing instructions to be executed by the one or more processors:
receiving an account binding request from a client for binding a target account of a first application to a user account of a third-party application, the account binding request including user information affiliated with the third-party application user account;
in response to the account binding request, searching an account managing database for a second user account of the first application corresponding to the user information;
initiating a binding process between the target account and the user account of the third-party application when the target account matches the second user account; and
when the target account does not match the second user account:
retrieving, from the account managing database, contact information of the second user account; and
sending a binding notification message to the second user account via the contact information, the binding notification message including information of the target account of the first application.

2. The method according to claim 1, further including:
receiving a binding confirmation message from the second user account via the contact information; and
in response to the binding confirmation message, completing account binding of the target account with the user account of the third-party application according to the user information.

3. The method according to claim 1, wherein the second user account of the first application corresponding to the user information includes a plurality of user accounts, each corresponding to at least a portion of the user information, the step of sending a binding notification message to the second user account via the contact information further includes:
identifying a priority level of each of the plurality of user accounts; and
sending the binding notification message to a user account having a highest priority level via the corresponding contact information.

4. The method according to claim 1, further comprising:
before receiving the account binding request:
sending an affiliated-account search request corresponding to the user information to an authorized account server associated with the third-party application;
receiving, from the authorized account server, a user account returned by the authorized account server in response to the affiliated-account search request; and
establishing a mapping relationship between the user information and the user account in the account managing database.

5. The method according to claim 1, where the step of searching an account managing database for a second user account of the first application corresponding to the user information includes:
generating one or more search keywords using one or more pieces of the user information;
sending a search request to a counting server, the search request including at least one of the search keywords; and
identifying, in the account managing database configured by the counting server, a user account corresponding to each search keyword.

6. The method according to claim 1, further comprising:
before comparing the target account with the second user account:
judging whether at least one user account the same as the target account exists in the account managing database according to the user information; and
determining, if yes, that at least one user account affiliated with the target account exists in the account managing database according to the target account.

7. The method according to claim 6, wherein the step of determining, if yes, that at least one user account affiliated with the target account exists in the account managing database according to the target account further comprises:
searching the account managing database for one or more affiliated accounts of the target account using the target account as a search keyword;
comparing each affiliated account found according to the target account with each user account found according to the user information; and
determining, if a same user account exists, that at least one user account affiliated with the target account exists in the found user accounts.

8. An account binding processing apparatus, including:
a receiving module, configured to receive an account binding request from a client for binding a target account of a first application to a user account of a third-party application, the account binding request including user information affiliated with the third-party application user account;
a search module, configured to, in response to the account binding request, search an account managing database for a second user account of the first application corresponding to the user information;
a binding processing module, configured to initiate a binding process between the target account and the user account of the third-party application when the target account matches the second user account; and
a notifying module, configured to retrieve, from the account managing database, contact information of the second user account and send a binding notification message to the second user account via the contact information, the binding notification message including information of the target account of the first application, when the target account does not match the second user account.

9. The apparatus according to claim 8, wherein the binding processing module is further configured to:
receive a binding confirmation message from the second user account via the contact information; and
in response to the binding confirmation message, complete account binding of the target account with the user account of the third-party application according to the user information.

10. The apparatus according to claim 9, wherein the second user account of the first application corresponding to the user information includes a plurality of user accounts, each corresponding to at least a portion of the user information, and the notifying module is configured to identify a priority level of each of the plurality of user accounts and send the binding notification message to a user account having a highest priority level via the corresponding contact information.

11. The apparatus according to claim 8, further including:
a configuration module, configured to send an affiliated-account search request corresponding to the user information to an authorized account server associated with the third-party application, receive, from the authorized account server, a user account returned by the authorized account server in response to the affiliated-account search request, and establish a mapping relationship between the user information and the user account in the account managing database.

12. The apparatus according to claim 8, wherein the search module is configured to generate one or more search keywords using one or more pieces of the user information; send a search request to a counting server, the search request including at least one of the search keywords; and identify, in the account managing database configured by the counting server, a user account corresponding to each search keyword

13. The apparatus according to claim 8, further comprising a judging module, further including:
a judging unit, configured to judge whether at least one user account the same as the target account exists in the account managing database according to the user information; and
a first determining unit, configured to determine, when a judging result of the judging unit is yes, that at least one user account affiliated with the target account exists in the account managing database according to the target account.

14. The apparatus according to claim 13, wherein the judging module further includes:
a search unit, configured to search the account managing database for one or more affiliated accounts of the target account using the target account as a search keyword;
a comparing unit, configured to compare each affiliated account found according to the target account with each user account found according to the user information; and
a second determining unit, configured to determine, when a comparing result of the comparing unit is that a same account exists, that at least one user account affiliated with the target account exists in the found user accounts.

15. An account binding processing system, including: a client and a binding server,
the client being configured to send an account binding request for binding a target account of a first application to a user account of a third-party application, the account binding request including user information affiliated with the third-party application user account; and
the binding server being configured to, in response to the account binding request, search an account managing database for a second user account of the first application corresponding to the user information; initiate a binding process between the target account and the user account of the third-party application when the target account matches the second user account; and when the target account does not match the second user account, retrieve, from the account managing database, contact information of the second user account; and send a binding notification message to the second user account via the contact information, the binding notification message including information of the target account of the first application.

16. The system according to claim 15, further including: a counting server, wherein:
the counting server is configured to send an affiliated-account search request corresponding to the user information to an authorized account server associated with the third-party application; receive, from the authorized account server, a user account returned by the authorized account server in response to the affiliated-account search request; and establish a mapping relationship between the user information and the user account in the account managing database.

17. The system according to claim 15, wherein the binding server is configured to generate one or more search keywords using one or more pieces of the user information; send a search request to a counting server, the search request including at least one of the search keywords; and identify, in the account managing database configured by the counting server, a user account corresponding to each search keyword.
